(19) United States
(12) Patent Application Publication
(10) Pub. No.: US 2026/0236547 A1
(43) Pub. Date: Aug. 13, 2026

(54) CONTEXTUALLY RELEVANT ITEM SELECTION

(71) Applicant: Walmart Apollo, LLC, Bentonville, AR (US)

(72) Inventors: Sujit Shambuling Horakeri, Hubli (IN); Harshal Tripathi, Sunnyvale, CA (US); He Wen, Menlo Park, CA (US); Chittaranjan Tripathy, Sunnyvale, CA (US)

(21) Appl. No.: 19/051,796

(22) Filed: Feb. 12, 2025

(51) Int. Cl. G06F 16/9538

(52) U.S. Cl. CPC G06F 16/9538

(57) ABSTRACT

Example implementations related to generating interfaces for set completion and/or augmentation using contextual information are disclosed. In an example, a set of items associated with a completed first process is received. A set of contextually relevant items is generated based on the set of items using at least one graph neural network and a set of ranked contextually relevant items is generated by applying a listwise ranker to the set of contextually relevant items. Instructions that cause a user device to display an interface including at least a portion of the set of ranked contextually relevant items in ranked order are generated and a selection of at least one item from the set of ranked contextually relevant items is received. A set of updated items including the set of items and the at least one item is generated and a second process is implemented for the set of updated items.

### TECHNICAL FIELD

This application relates generally to interface generation, and more particularly, to interface generation including contextual items for set completion or augmentation.

### BACKGROUND

Some network systems provide item suggestions via interface elements that are presented as part of an interface. Interface elements corresponding to one or more items may be selected based on historical data. Some network systems utilize current session data to select interface elements for inclusion in an interface.

### BRIEF DESCRIPTION OF THE DRAWINGS

Various examples will be described below with reference to the following figures.

FIG. 1 depicts an example system for context-aware post-selection interface generation and closed set augmentation, in accordance with some embodiments.

FIG. 2 depicts an example system for updating a post-selection recommendation model, in accordance with some embodiments.

FIG. 3 depicts a flow diagram illustrating a method of context-aware post-selection item addition, in accordance with some embodiments.

FIG. 4 depicts a flow diagram illustrating a method of context-aware post-selection item addition including re-ranking using current session signals, in accordance with some embodiments.

FIG. 5 depicts a flow diagram illustrating a method of updating a post-selection recommendation model, in accordance with some embodiments.

FIG. 6 depicts an example system with a machine-readable medium that includes instructions for context-aware post-selection item addition, in accordance with some embodiments.

FIG. 7 depicts an example system with a machine-readable medium that includes instructions for context-aware post-selection item addition including re-ranking using current session signals, in accordance with some embodiments.

FIG. 8 depicts an example system with a machine-readable medium that includes instructions for updating a post-selection recommendation model, in accordance with some embodiments.

FIG. 9 depicts an example computer system that implements one or more of the disclosed processes, in accordance with some embodiments.

### DETAILED DESCRIPTION

Some existing systems generate item recommendations that are presented via one or more interface elements in a generated interface. Although some current systems can generate complimentary items based on prior item selections or prior viewed items, such systems require a user to complete a selection of items before performing a first subsequent processing step and do not allow for adjustments of the selected items after execution of certain processing steps (e.g., the first subsequent processing step). For example, in an ecommerce network environment, current systems may require selection of a closed set of items (e.g., a cart) prior to executing a check-out or order completion process. After executing the order completion process, current systems may lock the closed set of items, preventing additions to the set, and further executing one or more additional processes, such as a fulfillment process.

The disclosed systems and methods provide interface element selection (e.g., item selection) for set augmentation of a closed set of items and facilitate modification of the closed set after a first post-selection process has been completed but before a second post-selection process has been executed or completed. After the closed set is generated and the first post-selection process has been completed, a set of ranked, contextually relevant item recommendations is generated and presented to a user. The set of ranked, contextually relevant item recommendations include items that complete or augment the closed set of items. The ranked, contextually relevant item recommendations may be generated based on historical item sets that include one or more items of the closed set of items. The disclosed systems and methods allow a user to select additional items for inclusion in the closed set of items prior to execution of a second post-selection process.

In some embodiments, the disclosed systems and methods provide interfaces that enable users to select additional items that a user may have forgotten or not been aware of for inclusion in one or more processes after completion of a selection process, reducing network resources (as additional selection processes and/or first post-selection processes need not be executed for the additional items), increasing user engagement with the network interfaces (e.g., providing additional engagement after the first post-selection process has executed), and enabling a continuous feedback loop for refinement of provided recommendations.

The disclosed systems and methods generate a post-selection interface that enables a user to add one or more additional items to a closed set of items after the closed set is the subject of the one or more post-selection processes. The post-selection interface includes interface elements representative of items that are contextually relevant to the closed set of items, for example, augmenting or completing one or more combinations within the closed set. In some embodiments, a user may interact with a post-selection interface to add additional items to the closed set to provide for simultaneous processing of the closed set and one or more added items by a second post-selection process.

In some embodiments, the generated post-selection interfaces include sets of additional items that are selected based on the closed set of items in order to provide targeted recommendations for completion of closed sets. For example, a user selecting items within a certain category may overlook one or more necessary complementary items that should have been included in the set of items. The disclosed systems and methods provide targeted recommendations for such complementary items, which increases user engagement with the provided interface.

In various embodiments, a system including a processor and a non-transitory memory storing instructions is disclosed. The instructions, when executed, cause the processor to receive a set of items associated with a completed first process, generate a set of contextually relevant items based on the set of items using at least one graph neural network, generate a set of ranked contextually relevant items by applying a listwise ranker to the set of contextually relevant items, generate instructions that cause a user device to display an interface including at least a portion of the set of ranked contextually relevant items in ranked order, receive a selection of at least one item from the set of ranked contextually relevant items, generate a set of updated items including the set of items and the at least one item, and implement a second process for the set of updated items.

In various embodiments, a computer-implemented method is disclosed. The computer-implemented method includes steps of receiving a closed set of items, generating a set of contextually relevant items based on the closed set of items using at least one graph neural network, generating a set of ranked contextually relevant items by applying a listwise ranker to the set of contextually relevant items, generating instructions that cause a user device to display an interface including at least a portion of the set of ranked contextually relevant items in ranked order, receiving a selection of at least one item from the set of ranked contextually relevant items, updating the closed set of items to include the at least one item, and implementing a fulfillment process for the closed set of items including the at least one item.

In various embodiments, a non-transitory computer-readable medium storing instructions. The instructions, when executed by at least one processor, cause a device to perform operations including receiving a closed set of items generated by a completed selection process, generating a set of ranked contextually relevant items using a post-selection recommendation model that generates a set of contextually relevant items based on the closed set of items using at least one graph neural network and generates the set of ranked contextually relevant items by applying a listwise ranker to the set of contextually relevant items, generating instructions that cause a user device to display an interface including at least a portion of the set of ranked contextually relevant items in ranked order, receiving a selection of at least one item from the set of ranked contextually relevant items, updating the closed set of items to include the at least one item, and implementing a fulfillment process for the closed set of items including the at least one item.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for generating a post-selection interface that enables additions to or augmentation of a closed set of items after the closed set is the subject of the one or more post-selection processes. In various embodiments, a closed set of items is received after one or more post-selection processing steps have been performed. A post-selection interface is generated based on the closed set of items. The post-selection interface includes one or more interface elements representative of contextually relevant items that may be added to the closed set of items to augment one or more other items or groups of items in the closed set. One or more selections may be made via the post-selection interface and selected items are added to the closed set. The updated closed set of items, including the one or more added items, is subsequently provided for additional processing.

For example, in the context of an e-commerce environment, a closed set of items may include a user order (or cart) that has undergone post-selection processing (e.g., a checkout process) to complete an order and pass the order for additional processing (e.g., fulfillment processing). After order completion, a post-order (e.g., post-selection) interface may be generated and presented including one or more contextually relevant items that augment or compliment one or more items in the closed set of items. A user may select, via a user device, one or more of the additional items to be added to the closed set of items in the order. The selected items are added to the closed set of items prior to the order being provided for fulfillment processing.

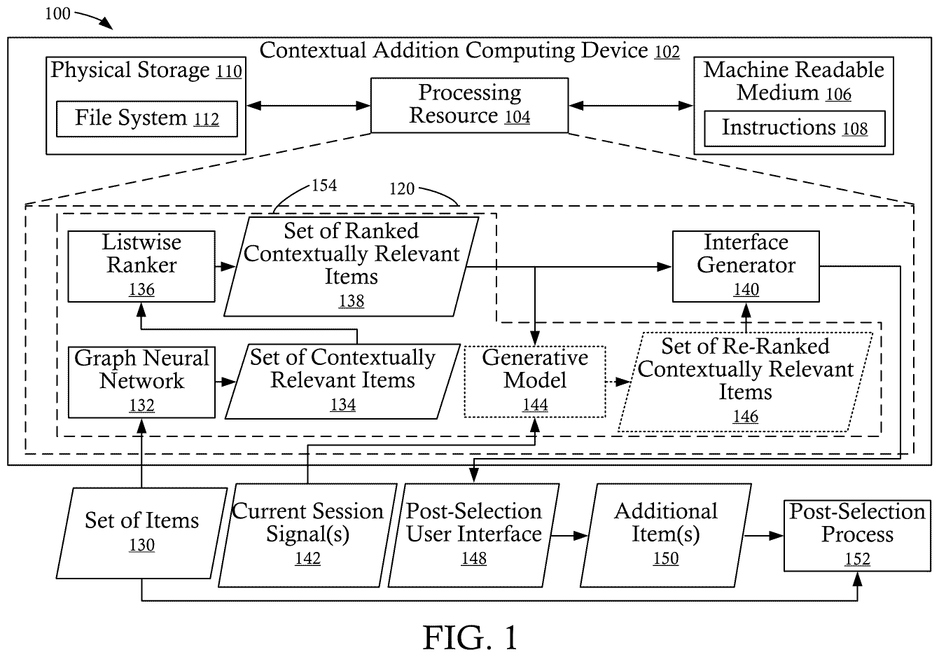

FIG. 1 depicts an example system 100 that provides context-aware post-selection interface generation and closed set augmentation, in accordance with some embodiments. The system 100 includes a post-selection computing device 102 that generates a post-selection interface based on a received closed set of items and generates a post-selection interface to enable augmentation of the closed set. The post-selection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The post-selection computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the post-selection computing device 102, such as generating a post-selection interface based on a received closed set of items or augmenting the closed set of items based on one or more additional items identified via a post-selection interface. The instructions 108 may include instructions for implementing one or more models. In some embodiments, and as will be described further herein below, the post-selection computing device 102 may execute one or more models, processes, or algorithms, such as a graph neural network (GNN) or a large language model (LLM) (e.g., as implemented as machine readable instructions) to select a set of post-selection interface elements for inclusion in a post-selection interface.

The post-selection computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the post-selection computing device 102. In some implementations, physical storage 110 may be accessed as a block storage device.

In some cases, the post-selection computing device 102 may also include a local file system 112 that may be implemented as a layer on top of the physical storage 110. For example, an operating system may be executing on the post-selection computing device 102 (by virtue of the processing resource 104 executing certain instructions 108 related to the operating system) and the operating system may provide a file system 112 to store data on the physical storage 110.

The post-selection computing device 102 may be in communication with one or more additional devices over one or more network channels. For example, in various embodiments, the post-selection computing device 102 may be in communication with a web server, a cloud-based engine including one or more processing devices that may be provisioned for use, a database, a workstation, and/or any other suitable system or device. The post-selection computing device 102 may similarly be in communication, either directly or indirectly, with one or more user computing devices operatively coupled over the network. The other computing systems may be similar to the post-selection computing device 102, and may each include at least a processing resource and a machine readable medium.

In some embodiments, the post-selection computing device 102 implements a post-selection augmenter 120 that enables additional items to be added to a closed set after a first post-selection process has been completed. For example, in some embodiments, a user may interact with one or more interfaces to identify a set of items 130. After selection, the set of items 130 may be provided to a first post-selection process. As one non-limiting example, a set of items 130 may be selected via an ecommerce network interface and the first post-selection process may include an order completion (e.g., checkout) process.

In some embodiments, after completion of the first post-selection process, the set of items 130 constitutes a closed set (e.g., items may not be added to or removed from the set). The closed set of items 130 may be provided to the post-selection augmenter 120. For example, in some embodiments, the closed set of items 130 is provided to a GNN 132. The set of items 130 may be provided directly from the first post-selection process and/or may be provided from one or more other processes (e.g., being provided simultaneously with execution of the first post-selection process).

In some embodiments, the GNN 132 generates a set of contextually relevant items 134 (e.g., relevant elements). The GNN 132 may implement a post-order analysis in order to identify relevant items (or other elements) within a catalog associated with the corresponding network system that are complementary to the set of items 130. The set of contextually relevant items 134 may include, for example, potential add-on items for completing item sets within the set of items 130, items for augmenting or modifying one or more items within the set of items 130, etc. In some embodiments, the set of contextually relevant items 134 include gap filling items selected to address one or more potential gaps or future needs for one or more of items in the set of items 130. In some embodiments, the set of contextually relevant items 134 may include one or more items that may be added to a closed set of items 130 and provided without any additional action or requirements by the user. For example, one or more free sample items may be included in the set of contextually relevant items 130.

In some embodiments, the GNN 132 includes a heterogenous item graph generated from historical interaction data to capture relationships between one or more items in an item catalog. The historical interaction data may include, but is not limited to, co-purchase data, co-view data, and/or order amendment data. The GNN 132 utilizes the heterogenous item graph to generate the set of contextually relevant items 134 based on the closed set of items 130. Application of the GNN 132 to the set of items 130 generates a set of contextually relevant items 134 that are tailored to the set of items 130 and to the corresponding user. In some embodiments, the GNN 132 is optimized for application after completion of the first post-selection process.

In some embodiments, the set of contextually relevant items 134 is provided to a listwise ranker 136 that ranks the set of contextually relevant items 134 utilizing one or more item features and/or one or more user features. For example, in some embodiments, the listwise ranker 136 utilizes one or more features of the set of items 130 and/or other items in an item catalog such as co-purchase data, view counts, or add-to interactions. As another example, in some embodiments, the listwise ranker 136 utilizes one or more user features such as user-specific interaction history, historical user set amendments, or network interface interaction data. Although certain example embodiments are discussed herein, it will be appreciated that the listwise ranker 136 may utilize any suitable features, such as item features and/or user features, to rank the set of contextually relevant items 134.

The listwise ranker 136 may apply a cross-entropy normalized discounted cumulative gain (NDCG) process and/or may utilize a counterfactual based learning system. The counterfactual based learning system may learn from historical interaction data (e.g., clicks, add-to-cart, views). In some embodiments, the listwise ranker 136 may be executed at one or more predetermined intervals (e.g., every fifteen minutes, every thirty minutes, every sixty minutes, every ninety minutes) and/or include a continuous process responsive to user interactions.

In some embodiments, the listwise ranker 136 generates a set of ranked contextually relevant items 138 that may be provided for generation of a post-selection interface. For example, the set of ranked contextually relevant items 138 may be provided directly to an interface generator 140. In some embodiments, the GNN 132 and the listwise ranker 136 may be generated as, and/or combined into, a combined post-selection recommendation model that receives the set of items 130 and generates the set of ranked contextually relevant items 138 in a single process. For example, a post-selection recommendation model may implement a structure that includes both the GNN 132 and the listwise ranker 136 in an integrated process that selects items utilizing the GNN 132 and ranks items using a listwise ranker 136. Although certain example embodiments are discussed herein, it will be appreciated that the GNN 132 and the listwise ranker 136 may be separate structures, partially integrated structures, and/or fully integrated structures.

In some embodiments, the set of ranked contextually relevant items 138 is provided to a generative model 144 to re-rank the set of contextually relevant items 138 (e.g., generate a set of re-ranked contextually relevant items 146). The generative model 144 may be optionally utilized to provide additional user-specific context to generate the set of re-ranked contextually relevant items 146. In some embodiments, the generative model 144 may be selectively applied to only some users to decrease network resource usage while providing an increase interaction probability for a selected set of users (e.g., the generative model 144 may generate a set of re-ranked contextually relevant items 146 for a first set of users and is bypassed (e.g., skipped) for a second set of users).

In some embodiments, the generative model 144 includes an LLM that utilizes the set of items 130, current session signals (e.g., current session behavior) for a user corresponding to the set of items 130, and/or user preferences or user preference summaries to reorder the set of ranked contextually relevant items 138 to generate the set of re-ranked contextually relevant items 146. In some embodiments, the LLM applies a persona-based re-ranking process to generate the set of re-ranked contextually relevant items 146.

In some embodiments, the set of ranked contextually relevant items 138 (or the set of re-ranked contextually relevant items 146 in embodiments including use of the generative model 144) are provided to the interface generator 140, which generates instructions that are transmitted to a user device to cause display of a post-selection user interface 148. The post-selection user interface 148 may be generated by the interface generator 140 using any suitable process. For example, the interface generator 140 may obtain an interface template from a data store and populate the interface template with one or more interface elements, including interface elements representative of the set of ranked contextually relevant items 138 (or the set of re-ranked contextually relevant items 146). The post-selection user interface 148 (e.g., instructions for generating the post-selection user interface 148) may be provided to a user device and displayed via any suitable application, such as a network specific application, a web browser, etc.

In some embodiments, a selection of one or more additional items 150 is received from the user device. The additional items 150 may be selected through one or more interactions with the post-selection user interface 148 via the user device. For example, in some embodiments, a user may utilize one or more input elements, such as a touch screen, mouse, keyboard, etc., to select one or more the interface elements representative of one or more of the set of ranked contextually relevant items 138 (or the set of re-ranked contextually relevant items 146) included in the post-selection user interface 148.

In some embodiments, the set of items 130 and the one or more additional items 150 are provided to a post-selection process 152, e.g., a second post-selection process. The set of items 130 and the additional items 150 may be provided to the post-selection process 152 using any suitable format. For example, the set of items 130 may be modified to include the one or more additional items 150 by one or more modification or augmentation processes (not shown), each of the set of items 130 and the one or more additional items 150 may be independently provided and combined by the post-selection process into a single set of items, and/or may be provided in any other suitable format.

In some embodiments, the set of items 130 may be modified to generate a set of updated items (not shown) including the set of items 130 and the one or more additional items 150. The set of updated items may be substituted for the set of items 130 in one or more post-selection processes 152. For example, in some embodiments, a set of items 130 may be generated by a user selection process including a first post-selection process that generates the first set of items 130 as a closed set. A post-selection user interface 148 may be generated after completion of the first post-selection process and presented to a user as discussed above. One or more additional items 150 may be selected and an updated set of items may be generated and provided to a second post-selection process in place of the set of items 130.

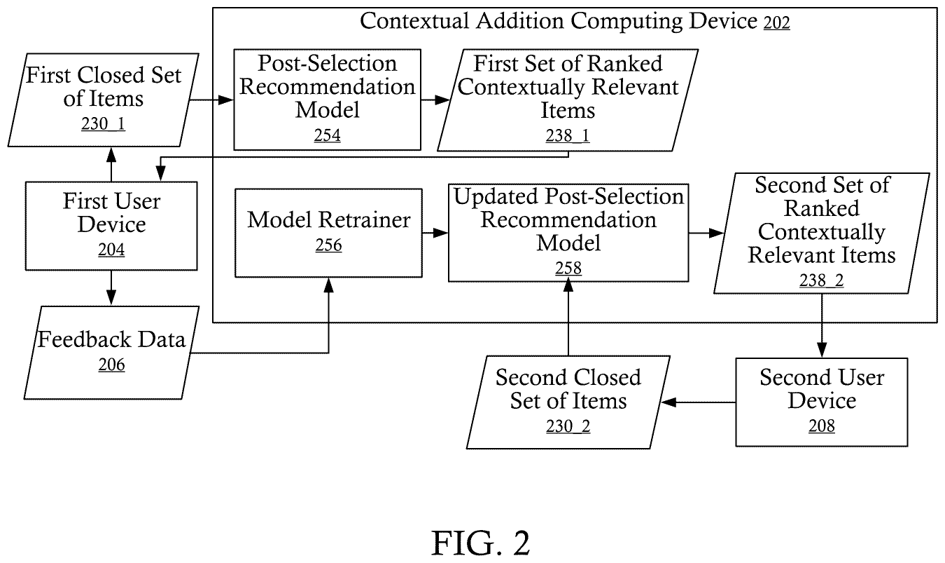

FIG. 2 depicts an example system 200 for updating a post-selection recommendation model 254, in accordance with some embodiments. The system 200 includes a contextual addition computing device 202. The contextual additional computing device 202 is similar to the post-selection computing device 102 discussed above with respect to FIG. 1 and each of the systems may be integrated into a single system and/or portions of one system may be implemented or included in one of the other systems disclosed herein.

In some embodiments, a first closed set of items 230_1 is received by a post-selection recommendation model 54. The first closed set of items 230_1 may be received from a first user device 204 and/or may be received as a result of one or more interactions performed via the first user device 204. For example, in some embodiments, a first user device 204 may be used to select one or more items to define the first closed set of items 230_1 and the first closed set of items 230_1 may be provided directly from the first user device 204 to the post-selection recommendation model 254. As another example, the first closed set of items 230_1 may be generated based on interactions of the first user device 204 and provided to one or more first post-selection processes. The first post-selection process may subsequently provide the first closed set of items 230_1 to the post-selection recommendation model 254.

As discussed above, a post-selection recommendation model 254 may include a GNN and/or a listwise ranker. The post-selection recommendation model 254 receives the first closed set of items 230 and generates a first set of ranked contextually relevant items 238. The post-selection recommendation model 254 may generate the first set of ranked contextually relevant items 238 by utilizing a GNN to identify contextually relevant items and a listwise ranker to rank the identified contextually relevant items, as discussed above with respect to FIG. 1. Although not illustrated, in some embodiments, the first set of ranked contextually relevant items 238 may be re-ranked by a generative model, for example, a generative model applying a persona-based ranking process, as discussed above.

The first set of ranked contextually relevant items 238_1 may be provided to the first user device 204. For example, the first set of ranked contextually relevant items 238_1 may be integrated into one or more post-selection interfaces that are provided to the first user device 204 via instructions that cause display of the one or more post-selection interfaces on the first user device 204. In some embodiments, the first user device 204 generates feedback data 206 based on the first set of ranked contextually relevant items 238_1. Feedback data 206 may include, but is not limited to, a selection of one or more items of the first set of ranked contextually relevant items 238_1 and/or an indication of relevance for one or more items of the first set of ranked contextually relevant items 238_1.

In some embodiments, the feedback data 206 is received by a model retrainer 256. The model retrainer 256 may receive additional training data, such as historical interaction data, current session interaction data, current basket contents, etc. The model retrainer 256 may apply an iterative training process to generate an updated post-selection recommendation model 258. The model retrainer 256 may generate the updated post-selection recommendation model 258 by modifying an existing post-selection recommendation model 254 and/or may generate the updated post-selection recommendation model 258 from one or more untrained frameworks utilizing training data including the feedback data 206.

A second closed set of items 230_2 may be received from a second user device 208. The second closed set of items 230_2 may be similar to the first closed set of items 230_1 and may be generated in a similar fashion. For example, in some embodiments, a second user device 208 may be used to select one or more items to define the second closed set of items 230_2 and the second closed set of items 230_2 may be provided directly from the second user device 208 to the updated post-selection recommendation model 258. As another example, the second closed set of items 230_2 may be generated based on interactions of the second user device 208 and provided to one or more first post-selection processes. The first post-selection process may subsequently provide the second closed set of items 230_2 to the updated post-selection recommendation model 258.

The updated post-selection recommendation model 258 generates a second set of ranked contextually relevant items 238_2 that is provided to the second user device 208. For example, the second set of ranked contextually relevant items 238_2 may be integrated into one or more post-selection interfaces that are provided to the second user device 208 via instructions that cause display of the one or more post-selection interfaces on the second user device 208. Although not shown in FIG. 2, it will be appreciated that additional feedback data may be received from the second user device 208 and utilized to generate a further updated post-selection recommendation model that may be utilized for one or more subsequently received closed sets of items.

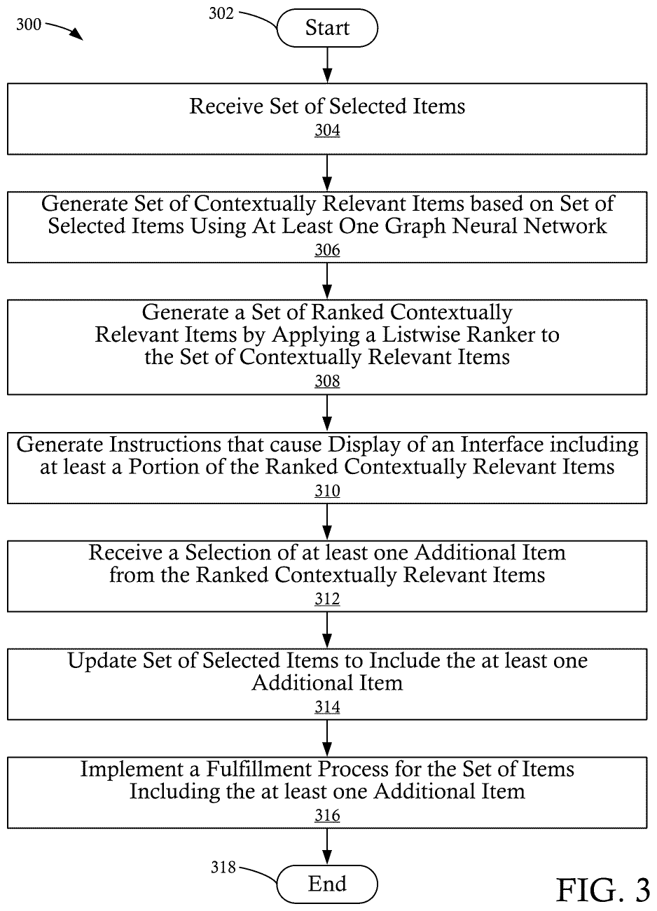

FIGS. 3-5 are flow diagrams depicting various example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 3-5 may be implemented in the form of executable instructions stored on a machine-readable medium and executed by a processing resource and/or in the form of electronic circuitry. For example, aspects of the methods may be described below as being performed by a post-selection augmentation process, an example of which may be the post-selection augmenter 120 running on a hardware processing resource 104 of the post-selection computing device 102 described above. Additionally, other aspects of the methods described below may be described with reference to other elements shown in FIG. 1 for non-limiting illustration purposes.

FIG. 3 depicts a flow diagram illustrating an example method 300 of context-aware post-selection item addition, in accordance with some embodiments. Method 300 starts at block 302 and continues to block 304, where a set of selected items is received. The set of selected items may include a closed set of items generated by a completed selection process and/or one or more post-selection processes. The set of selected items may include one or more items selected via a user interface, such as, for example, a user interface generated by an ecommerce network system.

At block 306, a set of contextually relevant items is generated based on the set of selected items. The set of contextually relevant items may be selected using at least one GNN. In some embodiments, the GNN implements a post-order analysis to identify relevant items (or other relevant interface elements) within a network store (such as a network catalog) associated with the corresponding network system that are complementary to the set of selected items. The set of contextually relevant items may include, for example, potential add-on items for completing item sets within the set of selected items, items for augmenting or modifying one or more items within the set of selected items, items necessary for operation of one or more items in the set of selected items, etc. In some embodiments, the set of contextually relevant items include gap filling items selected to address one or more potential gaps or future needs for one or more of items in the set of selected items and/or items identified for inclusion with one or more of the items in the set of selected items.

In some embodiments, the GNN includes a heterogenous item graph generated from historical interaction data to capture relationships between one or more items in an item catalog. The historical interaction data may include, but is not limited to, co-purchase data, co-view data, and/or order amendment data. The GNN utilizes the heterogenous item graph to generate the set of contextually relevant items based on the set of selected items. Application of the GNN to items included in the set of selected items generates a set of contextually relevant items that are tailored to the set of selected items and to the corresponding user. In some embodiments, the GNN is optimized for application after completion of the first post-selection process. The GNN may apply a complementary amendment rule, an indirect amendment rule, an order completion rule, or a combination thereof.

At block 308, a set of ranked contextually relevant items are generated by applying a listwise ranker to the set of contextually relevant items. The listwise ranker may utilize one or more features of the set of selected items and/or other items in an item catalog and/or may utilize the one or more user features of a corresponding user. Although certain example embodiments are discussed herein, it will be appreciated that the listwise ranker may utilize any suitable features, such as item features and/or user features, to rank the set of contextually relevant items. In some embodiments, the listwise ranker applies a cross-entropy normalized discounted cumulative gain (NDCG) process and/or may utilize a counterfactual based learning system. The counterfactual based learning system may learn from historical interaction data (e.g., clicks, add-to-cart, views). In some embodiments, the listwise ranker may be executed at one or more predetermined intervals (e.g., every fifteen minutes, every thirty minutes, every sixty minutes, every ninety minutes) and/or include a continuous process responsive to user interactions.

At block 310, instructions are generated that cause a user device to display an interface including at least a portion of the set of ranked contextually relevant items. The interface may include a post-selection interface presented via a user device after completion of one or more selection processes and/or post-selection processes. The post-selection interface may be generated by obtaining an interface template from a data store and populating the interface template with one or more interface elements, including interface elements representative of the portion of the set of ranked contextually relevant items to be included. The instructions may be provided to a user device and displayed via any suitable application, such as a network specific application, a web browser, etc.

At block 312, a selection of at least one item from the set of ranked contextually relevant items is received. The at least one item may be selected through one or more interactions with the post-selection user interface via the user device. For example, in some embodiments, a user may utilize one or more input elements, such as a touch screen, mouse, keyboard, etc., to select one or more the interface elements representative of one or more of contextually relevant items included in the post-selection user interface from the set of ranked contextually relevant items.

At block 314, the set of selected items is updated to include the items selected from the set of ranked contextually relevant items via the post-selection interface. At block 316, a post-selection process, such as a fulfillment process, is implemented for the updated set of items. At block 318, the method 300 ends.

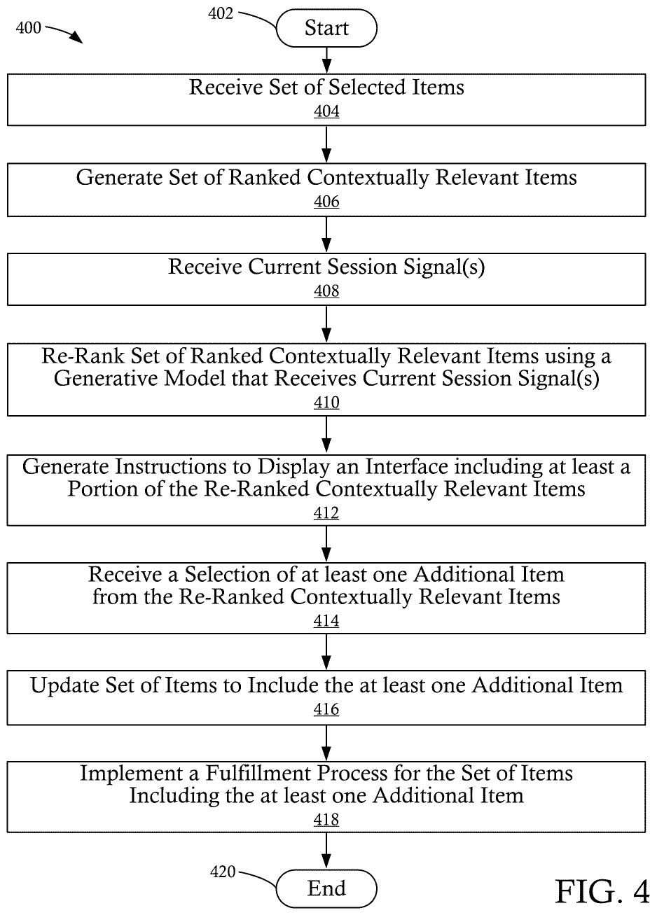

FIG. 4 depicts a flow diagram illustrating an example method 400 of context-aware post-selection item addition including re-ranking using current session signals, in accordance with some embodiments. Method 400 starts at block 402 and continues to block 404, where a set of selected items is received. Block 404 is similar to block 304 discussed above with respect to FIG. 3. At block 406, a set of ranked contextually relevant items is generated based on the set of selected items. In some embodiments, the set of ranked contextually relevant items is generated at block 406 in accordance with blocks 306 and 308 discussed above with respect to FIG. 3.

At block 408, one or more current session signals are received. The current session signals may be representative of a current session for a user with the corresponding network system. For example, the current session signals my include one or more signals representative of interactions performed by the user during a selection process, one or more pre-selection processes, and/or any other suitable interactions. The current session signals may additionally and/or alternatively include historical user data associated with the corresponding user.

At block 410, the set of ranked contextually relevant items are re-ranked using a generative model that receives the one or more current session signals. The generative model may include an LLM that utilizes, at least in part, the current session signals to reorder the set of ranked contextually relevant items to generate a set of re-ranked ranked contextually relevant items. In some embodiments, the LLM applies a persona-based ranking process to generate the set of re-ranked contextually relevant items.

At block 412, instructions are generated that cause a user device to display an interface including at least a portion of the set of re-ranked contextually relevant items. The interface may include a post-selection interface presented via a user device after completion of one or more selection processes and/or post-selection processes. The post-selection interface may be generated by obtaining an interface template from a data store and populating the interface template with one or more interface elements, including interface elements representative of the portion of the set of re-ranked contextually relevant items to be included. The instructions may be provided to a user device and displayed via any suitable application, such as a network specific application, a web browser, etc.

At block 414, a selection of at least one item from the set of re-ranked contextually relevant items is received. The at least one item may be selected through one or more interactions with the post-selection user interface via the user device. For example, in some embodiments, a user may utilize one or more input elements, such as a touch screen, mouse, keyboard, etc., to select one or more the interface elements representative of one or more of contextually relevant items included in the post-selection user interface from the set of re-ranked contextually relevant items.

At block 416, the set of selected items is updated to include the items selected from the set of re-ranked contextually relevant items via the post-selection interface. At block 418, a post-selection process, such as a fulfillment process, is implemented for the updated set of items. At block 420, the method 400 ends.

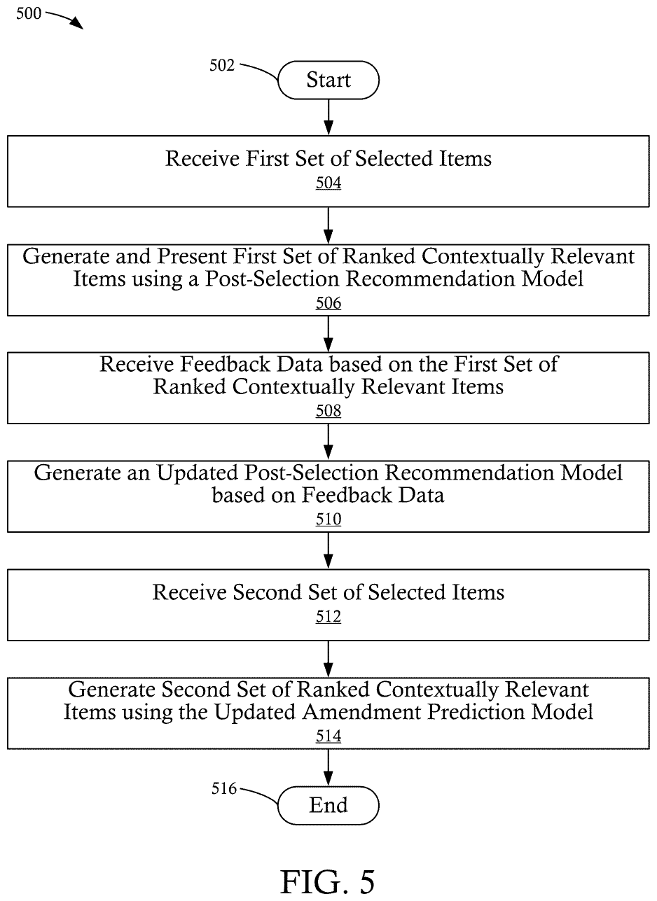

FIG. 5 depicts a flow diagram illustrating an example method 500 of updating a post-selection recommendation model, in accordance with some embodiments. Method 500 starts at block 502 and continues to block 504, where a first set of selected items is received. The first set of selected items may include a closed set of items generated by one or more selection processes and/or post-selection processes. For example, in some embodiments, the first set of selected items may include a closed set generated by a selection process implemented via a first user device.

At block 506, a first set of ranked contextually relevant items is generated using a post-selection recommendation model and presented via at least one post-selection interface. The first set of ranked contextually relevant items may be generated and provided, for example, as discussed above with respect to blocks 306-310 of method 300 and/or blocks 406-412 of method 400 discussed above. The first set of ranked contextually relevant items may be provided to the first user device.

At block 508, feedback data is received based on the first set of ranked contextually relevant items. Feedback data may include, but is not limited to, a selection of one or more items of the first set of ranked contextually relevant items or an indication of relevance for one or more items of the first set of ranked contextually relevant items. In some embodiments, feedback data includes interaction data for at least one post-selection interface including at least a portion of the first set of ranked contextually relevant items.

At block 510, an updated post-selection recommendation model is generated based, at least in part, on the feedback data. For example, in some embodiments, a model retrainer may apply an iterative training process to generate an updated post-selection recommendation model. The model retrainer may generate the updated post-selection recommendation model by modifying an existing post-selection recommendation model and/or may generate the updated post-selection recommendation model from one or more untrained frameworks utilizing training data including the feedback data.

At block 512, a second set of selected items is received. The second set of selected items may include a second closed set of items generated by one or more selection processes and/or post-selection processes. For example, in some embodiments, the second set of selected items may include a closed set generated by a selection process implemented via a second user device.

At block 514, a second set of ranked contextually relevant items is generated using the updated post-selection recommendation model. The second set of ranked contextually relevant items may be generated, for example, as discussed above with respect to blocks 306, 308 of method 300 and/or blocks 406-410 of method 400 discussed above. The second set of ranked contextually relevant items may be provided to the second user device. At block 516, the method 500 ends.

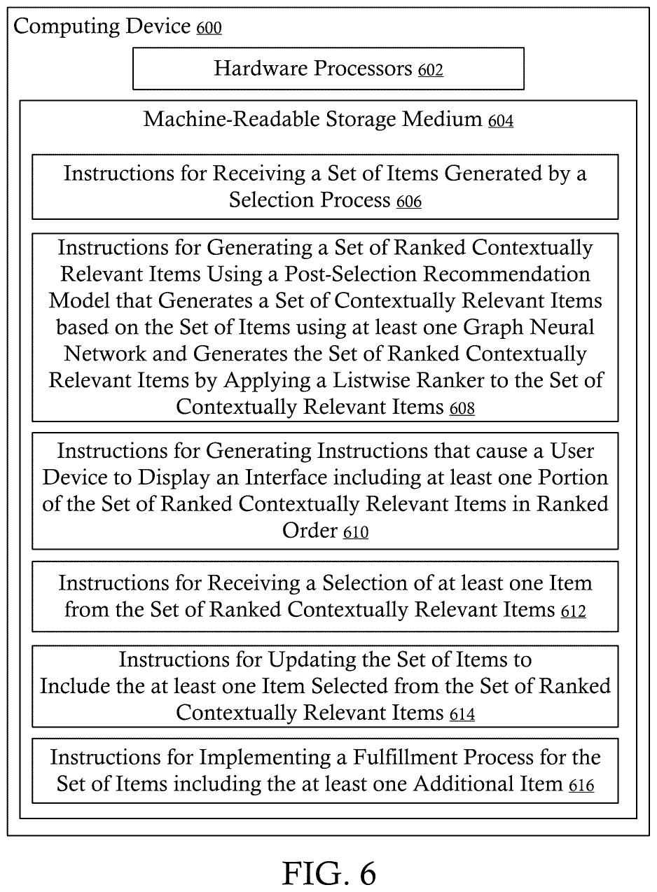

FIGS. 6-8 depict example systems 600, 700, 800 that each include a non-transitory, machine-readable medium 604, 704, 804 encoded with example instructions executable by a processing resource 602, 702, 802. In some implementations, a system 600, 700, 800 may be useful for implementing aspects of the post-selection augmenter 120 of FIG. 1, the system 200 of FIG. 2, or for performing aspects of the methods 300, 400, 500 of FIGS. 3-5. For example, the instructions encoded on a machine-readable medium 604, 704, 804 may be included in instructions 108 of FIG. 1. In some implementations, functionality described with respect to FIG. 1 may be included in the instructions encoded on a machine-readable medium 604, 704, 804.

A processing resource 602, 702, 802 may include a microcontroller, a microprocessor, central processing unit core(s), an ASIC, an FPGA, and/or other hardware device suitable for retrieval and/or execution of instructions from the machine-readable medium 604, 704, 804 to perform functions related to various examples. Additionally, or alternatively, the processing resource 602, 702, 802 may include or be coupled to electronic circuitry or dedicated logic for performing some or all of the functionality of the instructions described herein.

The machine-readable medium 604, 704, 804 may be any medium suitable for storing executable instructions, such as RAM, ROM, EEPROM, flash memory, a hard disk drive, an optical disc, or the like. In some example implementations, the machine-readable medium 604, 704, 804 may be a tangible, non-transitory medium. The machine-readable medium 604, 704, 804 may be disposed within the systems 600, 700, 800, in which case the executable instructions may be deemed installed or embedded on the system. Alternatively, the machine-readable medium 604, 704, 804 may be a portable (e.g., external) storage medium, and may be part of an installation package.

As described further herein, the machine-readable medium 604, 704, 804 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 6-8.

With reference to FIG. 6, the machine-readable medium 604 includes instructions 606-616. Instructions 606, when executed, cause the processing resource 602 to receive a set of items generated by a selection process. The set of selected items may include one or more items selected via a user interface, such as, for example, a user interface generated by an ecommerce network system.

Instructions 608, when executed, cause the processing resource 602, to generate a set of ranked contextually relevant items using a post-selection recommendation model. The post-selection recommendation model may generate a set of contextually relevant items based on the set of selected items using at least one GNN and may generate the set of ranked contextually relevant items by applying a listwise ranker to the set of contextually relevant items. In some embodiments, the GNN implements a post-order analysis to identify relevant items (or other relevant interface elements) within a network store (such as a network catalog) associated with the corresponding network system that are complementary to the set of selected items.

The set of contextually relevant items may include, for example, potential add-on items for completing item sets within the set of selected items, items for augmenting or modifying one or more items within the set of selected items, items necessary for operation of one or more items in the set of selected items, etc. In some embodiments, the set of contextually relevant items include gap filling items selected to address one or more potential gaps or future needs for one or more of items in the set of selected items. In some embodiments, the set of contextually relevant items may include one or more items that may be added to a closed set of items and provided without any additional action or requirements by the user.

In some embodiments, the GNN includes a heterogenous graph (e.g., a heterogenous item graph) generated from historical interaction data to capture relationships between one or more items in an item catalog. The historical interaction data may include, but is not limited to, co-purchase data, co-view data, and/or order amendment data. The GNN utilizes the heterogenous graph to generate the set of contextually relevant items based on the set of selected items. Application of the GNN to items included in the set of selected items generates a set of contextually relevant items that are tailored to the set of selected items and to the corresponding user. In some embodiments, the GNN is optimized for application after completion of the first post-selection process.

The listwise ranker may utilize one or more features of the set of selected items and/or other items in an item catalog and/or may utilize the one or more user features of a corresponding user. Although certain example embodiments are discussed herein, it will be appreciated that the listwise ranker may utilize any suitable features, such as item features and/or user features, to rank the set of contextually relevant items. In some embodiments, the listwise ranker applies a cross-entropy normalized discounted cumulative gain (NDCG) process and/or may utilize a counterfactual based learning system. The counterfactual based learning system may learn from historical interaction data (e.g., clicks, add-to-cart, views). In some embodiments, the listwise ranker may be executed at one or more predetermined intervals (e.g., every fifteen minutes, every thirty minutes, every sixty minutes, every ninety minutes) and/or include a continuous process responsive to user interactions.

Instructions 610, when executed, cause the processing resource 602, to generate instructions that cause a user device to display an interface including at least a portion of the set of ranked contextually relevant items. The interface may include a post-selection interface presented via a user device after completion of one or more selection processes and/or post-selection processes. The post-selection interface may be generated by obtaining an interface template from a data store and populating the interface template with one or more interface elements, including interface elements representative of the portion of the set of ranked contextually relevant items to be included. The instructions may be provided to a user device and displayed via any suitable application, such as a network specific application, a web browser, etc.

Instructions 612, when executed, cause the processing resource 602, to receive a selection of at least one item from the set of ranked contextually relevant items. The at least one item may be selected through one or more interactions with the post-selection user interface via the user device. For example, in some embodiments, a user may utilize one or more input elements, such as a touch screen, mouse, keyboard, etc., to select one or more the interface elements representative of one or more of the set of ranked contextually relevant items included in the post-selection user interface.

Instructions 614, when executed, cause the processing resource 602, to update the set of selected items is updated to include the at least one item selected from the set of ranked contextually relevant items via the post-selection interface. Instructions 616, when executed, cause the processing resource 602, to implement a post-selection process, such as a fulfillment process, for the updated set of items.

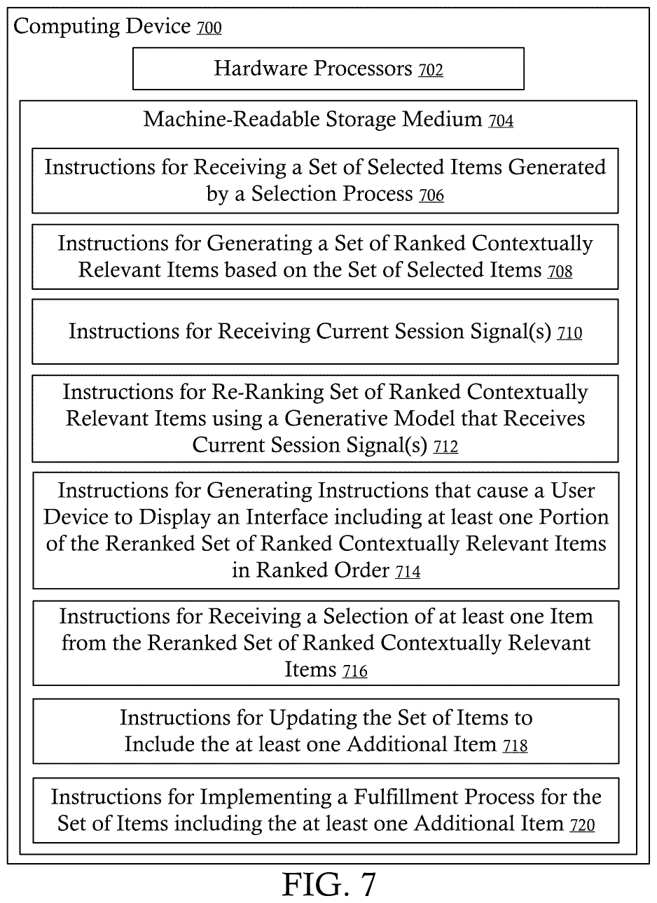

With reference to FIG. 7, the machine-readable medium 704 includes instructions 706-720. Instructions 706, when executed, cause the processing resource 702 to receive a set of selected items. Instructions 708, when executed, cause the processing resource 702 to generate a set of ranked contextually relevant items based on the set of selected items. In some embodiments, the set of ranked contextually relevant items is generated according to instructions 608 discussed above with respect to FIG. 6.

Instructions 710, when executed, cause the processing resource 702 to receive one or more current session signals. The current session signals may be representative of a current session for a user with the corresponding network system. For example, the current session signals my include one or more signals representative of interactions performed by the user during a selection process, one or more pre-selection processes, and/or any other suitable interactions. The current session signals may additionally and/or alternatively include historical user data associated with the corresponding user.

Instructions 712, when executed, cause the processing resource 702 to re-rank the set of ranked contextually relevant items using a generative model that receives the one or more current session signals. The generative model may include an LLM that utilizes, at least in part, the current session signals to reorder the set of ranked contextually relevant items to generate a set of re-ranked ranked contextually relevant items. In some embodiments, the LLM applies a persona-based ranking process to generate the set of re-ranked contextually relevant items.

Instructions 714, when executed, cause the processing resource 702 to generate instructions that cause a user device to display an interface including at least a portion of the set of re-ranked contextually relevant items in ranked order. The interface may include a post-selection interface presented via a user device after completion of one or more selection processes and/or post-selection processes. The post-selection interface may be generated by obtaining an interface template from a data store and populating the interface template with one or more interface elements, including interface elements representative of the portion of the set of re-ranked contextually relevant items to be included. The instructions may be provided to a user device and displayed via any suitable application, such as a network specific application, a web browser, etc.

Instructions 716, when executed, cause the processing resource 702 to receive a selection of at least one item from the set of re-ranked contextually relevant items. The at least one item may be selected through one or more interactions with the post-selection user interface via the user device. For example, in some embodiments, a user may utilize one or more input elements, such as a touch screen, mouse, keyboard, etc., to select one or more the interface elements representative of one or more of the set of re-ranked contextually relevant items included in the post-selection user interface.

Instructions 718, when executed, cause the processing resource 702 to update the set of selected items to include the items selected from the set of re-ranked contextually relevant items via the post-selection interface. Instructions 720, when executed, cause the processing resource 702 to implement a post-selection process, such as a fulfillment process, for the updated set of items.

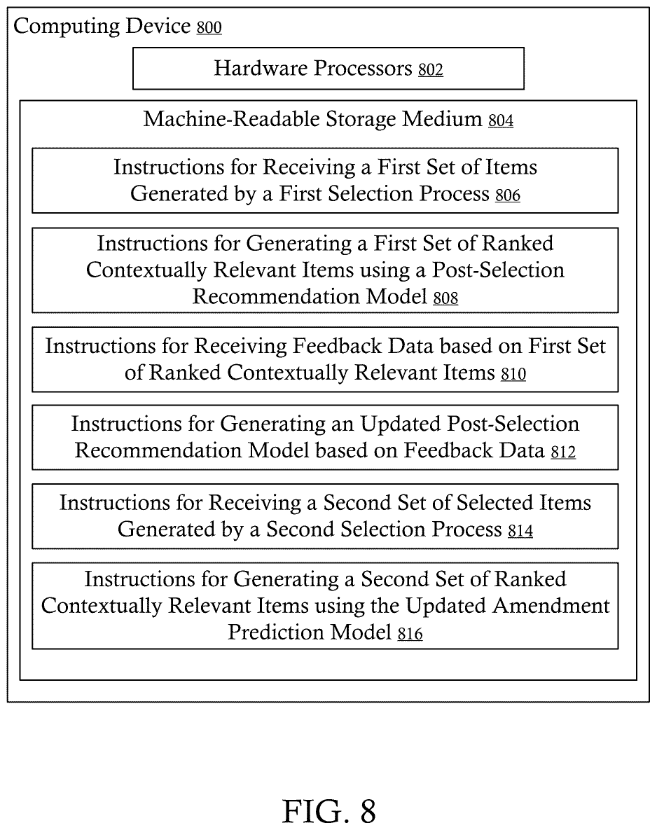

With reference to FIG. 8, the machine-readable medium 804 includes instructions 806-816. Instructions 806, when executed, cause the processing resource 802 to receive a first set of selected items is received. The first set of selected items may include a closed set of items generated by one or more first selection processes and/or post-selection processes. For example, in some embodiments, the first set of selected items may include a closed set generated by a selection process implemented via a first user device.

Instructions 808, when executed, cause the processing resource 802 to generate a first set of ranked contextually relevant items using a post-selection recommendation model and presented via at least one post-selection interface. The first set of ranked contextually relevant items may be generated and provided, for example, as discussed above with respect to instructions 608, 610 of FIG. 6 and/or instructions 708-714 of FIG. 7 discussed above. The first set of ranked contextually relevant items may be provided to the first user device.

Instructions 810, when executed, cause the processing resource 802 to receive feedback data based on the first set of ranked contextually relevant items. Feedback data may include, but is not limited to, a selection of one or more items of the first set of ranked contextually relevant items or an indication of relevance for one or more items of the first set of ranked contextually relevant items. In some embodiments, feedback data includes interaction data for at least one post-selection interface including at least a portion of the first set of ranked contextually relevant items.

Instructions 812, when executed, cause the processing resource 802 to generate an updated post-selection recommendation model based, at least in part, on the feedback data. For example, in some embodiments, a model retrainer may apply an iterative training process to generate an updated post-selection recommendation model. The model retrainer may generate the updated post-selection recommendation model by modifying an existing post-selection recommendation model and/or may generate the updated post-selection recommendation model from one or more untrained frameworks utilizing training data including the feedback data.

Instructions 814, when executed, cause the processing resource 802 to receive a second set of selected items. The second set of selected items may include a second closed set of items generated by one or more second selection processes and/or post-selection processes. For example, in some embodiments, the second set of selected items may include a closed set generated by a selection process implemented via a second user device. Instructions 816, when executed, cause the processing resource 802 to generate a second set of ranked contextually relevant items using the updated post-selection recommendation model.

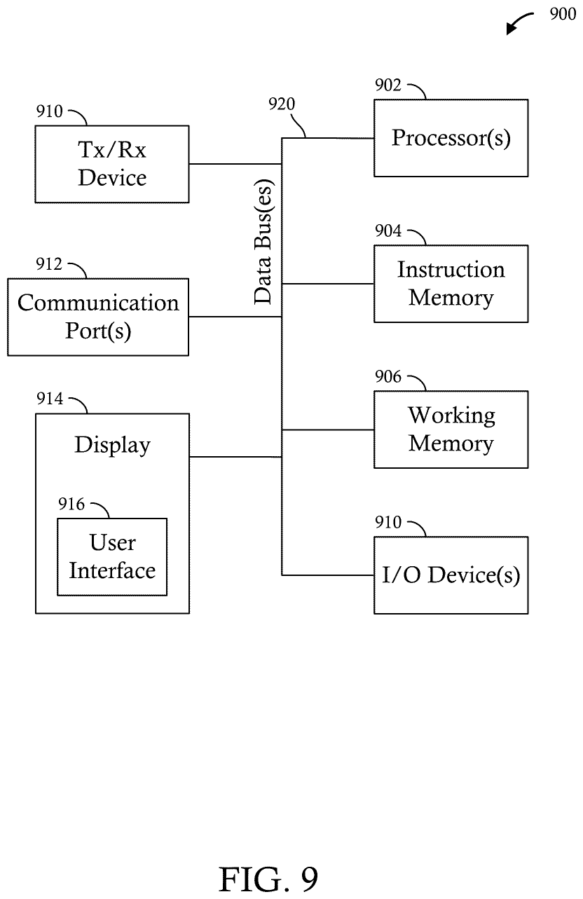

FIG. 9 illustrates a block diagram of a computing device 900, in accordance with some embodiments. Although FIG. 9 is described with respect to certain components shown therein, it will be appreciated that the elements of the computing device 900 may be combined, omitted, and/or replicated. In addition, it will be appreciated that additional elements other than those illustrated in FIG. 9 may be added to the computing device.

As shown in FIG. 9, the computing device 900 may include one or more processing resources 902, instruction memory 904, working memory 906, input/output devices 908, transceiver 910, communication ports 912, display 914, and/or any other suitable elements each operatively coupled to one or more data buses 920. The data buses 920 allow for communication among the various components. The data buses 920 may include wired, or wireless, communication channels.

The one or more processing resources 902 may include any processing circuitry operable to control operations of the computing device 900. In some embodiments, the one or more processing resources 902 include one or more distinct processors, each having one or more cores (e.g., processing circuits). Each of the distinct processors may have the same or different structure. The one or more processing resources 902 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 902 may also be implemented by a controller, a microcontroller, an application specific integrated circuit (ASIC), a field programmable gate array (FPGA), a programmable logic device (PLD), etc.

In some embodiments, the one or more processing resources 902 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 904 may store instructions that are accessed (e.g., read) and executed by at least one of the one or more processing resources 902. For example, the instruction memory 904 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 902 may perform a certain function or operation by executing code, stored on the instruction memory 904, embodying the function or operation. For example, the one or more processing resources 902 may execute code stored in the instruction memory 904 to perform one or more of any function, method, or operation disclosed herein.

Additionally, the one or more processing resources 902 may store data to, and read data from, the working memory 906. For example, the one or more processing resources 902 may store a working set of instructions to the working memory 906, such as instructions loaded from the instruction memory 904. The one or more processing resources 902 may also use the working memory 906 to store dynamic data created during one or more operations. The working memory 906 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 904 and working memory 906, it will be appreciated that the computing device 900 may include a single memory unit that operates as both instruction memory and working memory. Further, although embodiments are discussed herein including non-volatile memory, it will be appreciated that computing device 900 may include volatile memory components in addition to at least one non-volatile memory component.

In some embodiments, the instruction memory 904 and/or the working memory 906 includes an instruction set, in the form of a file for executing various methods, such as methods for generating post-selection interfaces including items that are contextually relevant to a closed set of items and/or augmenting the closed set based on selections made via the post-selection interface, as described herein. The instruction set may be stored in any acceptable form of machine-readable instructions, including source code or various appropriate programming languages. Some examples of programming languages that may be used to store the instruction set include, but are not limited to: Java, Javascript, C, C++, C#, Python, Objective-C, Visual Basic, . NET, HTML, CSS, SQL, NoSQL, Rust, Perl, etc. In some embodiments a compiler or interpreter converts the instruction set into machine executable code for execution by the one or more processing resources 902.

The input/output devices 908 may include any suitable device that allows for data input or output. For example, the input/output devices 908 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 910 and/or the communication port(s) 912 allow for communication with a network. For example, if a communication network is a cellular network, the transceiver 910 allows communications with the cellular network. In some embodiments, the transceiver 910 is selected based on the type of the communication network the computing device 900 will be operating in. The one or more processing resources 902 are operable to receive data from, or send data to, a network, via the transceiver 910.

The communication port(s) 912 may include any suitable hardware, software, and/or combination of hardware and software that is capable of coupling the computing device 900 to one or more networks and/or additional devices. The communication port(s) 912 may be arranged to operate with any suitable technique for controlling information signals using a desired set of communications protocols, services, or operating procedures. The communication port(s) 912 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 912 allows for the programming of executable instructions in the instruction memory 904. In some embodiments, the communication port(s) 912 allow for the transfer (e.g., uploading or downloading) of data, such as machine learning model training data.

In some embodiments, the communication port(s) 912 couples the computing device 900 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 910 and/or the communication port(s) 912 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 914 may be any suitable display, and may display the user interface 916. The user interfaces 916 may enable user interaction with one or more selection interfaces and/or post-selection interfaces. For example, the user interface 916 may be a user interface for an application of a network environment operator that allows a user to view and interact with the operator's website. In some embodiments, a user may interact with the user interface 916 by engaging the input/output devices 908. In some embodiments, the display 914 may be a touchscreen, where the user interface 916 is displayed on the touchscreen.

The display 914 may include a screen such as, for example, a Liquid Crystal Display (LCD) screen, a light-emitting diode (LED) screen, an organic LED (OLED) screen, a movable display, a projection, etc. In some embodiments, the display 914 may include a coder/decoder, also known as Codecs, to convert digital media data into analog signals. For example, the visual peripheral output device may include video Codecs, audio Codecs, or any other suitable type of Codec.

In some embodiments, the computing device 900 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 900 may be a computer, a workstation, a laptop, a server such as a cloud-based server, or any other suitable device. In some embodiments, the computing device 900 is a server that includes one or more processing units, such as one or more graphical processing units (GPUs), one or more central processing units (CPUs), and/or one or more processing cores. The computing device 900 may, in some embodiments, execute one or more virtual machines. In some embodiments, processing resources (e.g., capabilities) of the computing device 900 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that identification of contextually relevant items as disclosed herein, particularly on large datasets intended to be used ecommerce network systems, is only possible with the aid of computer-assisted machine-learning algorithms and techniques, such as the disclosed post-selection recommendation model. In some embodiments, machine learning processes including post-selection recommendation models are used to perform operations that cannot practically be performed by a human, either mentally or with assistance, such as identification of contextually relevant items based on a closed set for inclusion in a post-selection interface.

Although the subject matter has been described in terms of example embodiments, it is not limited thereto. Rather, the appended claims should be construed broadly, to include other variants and embodiments that may be made by those skilled in the art.

1. A system, comprising:
a processor; and
a non-transitory memory storing instructions that, when executed, cause the processor to:
receive a set of items associated with a completed first post-selection process;
generate a set of contextually relevant items based on the set of items using at least one graph neural network;
generate a set of ranked contextually relevant items by applying a listwise ranker to the set of contextually relevant items;
generate instructions that cause a user device to display an interface including at least a portion of the set of ranked contextually relevant items in ranked order;
receive a selection of at least one item from the set of ranked contextually relevant items;
generate a set of updated items including the set of items and the at least one item by adding the at least one item from the set of ranked contextually relevant items to the set of items associated with the completed first post-selection process; and
implement a second post-selection process for the set of updated items to provide for processing of the set of items and the at least one item, wherein the at least one graph neural network is optimized for first post-selection process application.

2. The system of claim 1, wherein the at least one graph neural network comprises a heterogenous graph.

3. The system of claim 1, wherein the instructions cause the processor to:
receive at least one current session signal; and
prior to generating instructions that cause the user device to display the interface, re-rank the set of ranked contextually relevant items using a generative model that receives the set of ranked contextually relevant items and the at least one current session signal.

4. The system of claim 3, wherein the generative model utilizes persona-based re-ranking.

5. The system of claim 1, wherein the listwise ranker applies cross-entropy normalized discounted cumulative gain (NDCG).

6. (canceled)

7. The system of claim 1, wherein the at least one graph neural network applies a complementary amendment rule, an indirect amendment rule, an order completion rule, or a combination thereof.

8. The system of claim 7, wherein the instructions cause the processor to:
receive feedback data based on the set of ranked contextually relevant items;
generate an updated post-selection recommendation model based at least in part on the feedback data;
receive a second set of items associated with a second completed first process; and
generate a second set of ranked contextually relevant items using the updated post-selection recommendation model.

9. A computer-implemented method, comprising:
receiving a closed set of items associated with a completed first post-selection process;
generating a set of contextually relevant items based on the closed set of items using at least one graph neural network;
generating a set of ranked contextually relevant items by applying a listwise ranker to the set of contextually relevant items;
generating instructions that cause a user device to display an interface including at least a portion of the set of ranked contextually relevant items in ranked order;
receiving a selection of at least one item from the set of ranked contextually relevant items;
updating the closed set of items to include the at least one item by adding the at least one item from the set of ranked contextually relevant items to the set of items associated with the completed first post-selection process; and
implementing a second post-selection process for the closed set of items including the at least one item to provide for processing of the set of items and the at least one item, wherein the at least one graph neural network and the listwise ranker comprise a post-selection recommendation model and wherein the at least one graph neural network is optimized for first post-selection process application.

10. The computer-implemented method of claim 9, wherein the at least one graph neural network comprises a heterogenous graph.

11. The computer-implemented method of claim 9, comprising:
receiving at least one current session signal; and
prior to generating instructions that cause the user device to display the interface, re-ranking the set of ranked contextually relevant items using a generative model that receives the set of ranked contextually relevant items and the at least one current session signal.

12. The computer-implemented method of claim 11, wherein the generative model utilizes persona-based re-ranking.

13. The computer-implemented method of claim 9, wherein the listwise ranker applies cross-entropy normalized discounted cumulative gain (NDCG).

14. (canceled)

15. The computer-implemented method of claim 9, comprising:
receiving feedback data based on the set of ranked contextually relevant items;
generating an updated post-selection recommendation model based at least in part on the feedback data;
receiving a second closed set of items; and
generating a second set of ranked contextually relevant items using the updated post-selection recommendation model.

16. A non-transitory computer-readable medium storing instructions that, when executed by at least one processor, cause a device to perform operations comprising:
receiving a closed set of items generated by a completed first post-selection process;
generating a set of ranked contextually relevant items using a post-selection recommendation model that generates a set of contextually relevant items based on the closed set of items using at least one graph neural network and generates the set of ranked contextually relevant items by applying a listwise ranker to the set of contextually relevant items;
generating instructions that cause a user device to display an interface including at least a portion of the set of ranked contextually relevant items in ranked order;
receiving a selection of at least one item from the set of ranked contextually relevant items;
updating the closed set of items to include the at least one item by adding the at least one item from the set of ranked contextually relevant items to the set of items associated with the completed first post-selection process; and
implementing a second post-selection process for the closed set of items including the at least one item to provide for processing of the set of items and the at least one item, wherein the at least one graph neural network is optimized for application after completion of the first post-selection process.

17. The non-transitory computer-readable medium of claim 16, wherein the at least one graph neural network comprises a heterogenous graph.

18. The non-transitory computer-readable medium of claim 16, wherein the instructions cause the device to perform operations comprising:
receiving at least one current session signal; and
prior to generating instructions that cause the user device to display the interface, re-ranking the set of ranked contextually relevant items using a generative model that receives the set of ranked contextually relevant items and the at least one current session signal.

19. The non-transitory computer-readable medium of claim 18, wherein the generative model utilizes persona-based re-ranking.

20. The non-transitory computer-readable medium of claim 16, wherein the listwise ranker applies cross-entropy normalized discounted cumulative gain (NDCG).
